(19) United States
(12) Patent Application Publication
(10) Pub. No.: US 2009/0197128 A1
(43) Pub. Date: Aug. 6, 2009

(54) Fuel Cell System Management System and Method

(75) Inventors: Karim Bencherif, Puteaux (FR); Didier Vannucci, Montrouge (FR); Emmanuel Devaud, Clamart (FR); Marielle Marchand, Gif Sur Yvette (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Renault s.a.s., Boulogne Billancourt (FR)

(21) Appl. No.: 10/589,734

(22) PCT Filed: Feb. 15, 2005
(86) PCT No.: PCT/FR05/50096

§ 371 Date: Dec. 19, 2008

(30) Foreign Application Priority Data
Feb. 17, 2004 (FR) 0401572

(51) Int. Cl. H01M 8/04; H01M 8/18

(52) U.S. Cl. 429/17; 429/19

(57) ABSTRACT

A fuel cell system management method, wherein a reformer is provided for supplying hydrogen-containing reformed gas to the fuel cell unit and a compressor is provided for supplying air to the fuel cell unit. The fuel cell unit includes cells arranged in modules. Voltages are measured across terminals of each cell of each module of the cell unit, and the voltage difference between the mean cell voltage for the cell unit and a predetermined mean cell voltage is calculated. The voltage difference is compared with a predetermined threshold voltage different, and the presence or absence of carbon monoxide poisoning in the fuel cell unit is determined based on the comparison.

Fuel cell system management method and system The present invention relates to a method and a system for managing a fuel cell system.

Fuel cell assemblies are used to supply energy either for stationary applications, or in the aeronautic or automotive field, and comprise a set of elementary cells.

The distribution of the fluids between the cells and the collectors, and the carbon monoxide concentration in the core of the fuel cell assembly, are factors for operating stability and strongly influence the electrical equilibrium of the fuel cell assembly.

U.S. Pat. No. 6,242,120 and patent application US 2002/0022167 describe methods in which a process parameter is measured, and this measurement or this cumulative measurement over a time interval is compared with a predetermined respective reference value, and according to the result, a drainage is initiated. These methods take no account of the voltages or voltage differences across the terminals of the cells of the fuel cell assembly. Nor do they take any account of cases of carbon monoxide poisoning of the fuel cell assembly.

Patent application EP 1 018 774 describes a method and a device for initiating drainages according to a measured pressure, the drainage taking place by gas recirculation. This document does not use the voltages across the terminals of the cells, and takes no account of the cases of carbon monoxide poisoning of the fuel cell assembly.

Patent applications WO 03/010845 and WO 03/010842 describe methods and devices initiating drainages above a mean cell voltage calculated by dividing a voltage across the terminals of a cell assembly by the number of cells of the cell assembly. A comparison of this value with a predetermined value serves to detect the presence of water flooding, and if any, a drainage is initiated. These documents take no account of the cases of carbon monoxide poisoning of the fuel cell assembly.

Accordingly, in view of the above, it is the object of the invention to manage the operation of a fuel cell assembly, in order to optimize its operation.

Thus, according to one aspect of the invention, a fuel cell system management method is proposed comprising a reformer for supplying a hydrogen-containing reformed gas to the fuel cell assembly and a compressor for supplying air to said fuel cell assembly, said fuel cell assembly consisting of cells arranged in N_{mod} modules. The method comprises steps in which:

voltages are measured across the terminals of each cell of each module of said cell assembly;

a voltage difference between the mean cell voltage Ū_{cell} for the cell assembly and a predetermined mean cell voltage U⁰_{cell} is calculated;

said voltage difference Ū_{cell}−U⁰_{cell} is compared with a predetermined threshold voltage difference ΔUₜₕᵣₑₛₕ; and

the presence of carbon monoxide poisoning in the cell assembly is determined if said voltage difference Ū_{cell}−U⁰_{cell} is equal to or greater than said predetermined threshold voltage difference ΔUₜₕᵣₑₛₕ, and the absence of carbon monoxide poisoning in the cell assembly is determined if said voltage difference Ū_{cell}−U⁰_{cell} is lower than said predetermined threshold voltage difference ΔUₜₕᵣₑₛₕ.

It is possible to determine the presence of carbon monoxide poisoning in the cell assembly. Carbon monoxide poisoning in the cell assembly means an accumulation of carbon monoxide in the cell assembly.

Voltage obviously means an electrical potential difference.

In one preferred embodiment, said predetermined mean cell voltage U⁰_{cell} and said predetermined threshold voltage difference ΔUₜₕᵣₑₛₕ depend on the operating mode of the fuel cell assembly, said fuel cell assembly comprising, as operating modes, a start mode, a nominal mode, and a stop mode.

In an advantageous embodiment, in case of the presence of carbon monoxide poisoning in the cell assembly, air is added to the reformed gas.

In a preferred embodiment, in case of the absence of carbon monoxide poisoning in the cell assembly:

a standard deviation σ_{Ucell} of said voltages measured across the terminals of the cells of the cell assembly is calculated;

said standard deviation σ_{Ucell} is compared with a predetermined threshold standard deviation σₜₕᵣₑₛₕ; and

the presence or absence of water flooding in the cell assembly is determined on the basis of said comparison, the presence of water flooding in the cell assembly being reflected by said standard deviation σ_{Ucell} being equal to or higher than said predetermined threshold standard deviation σₜₕᵣₑₛₕ, and the absence of water flooding in the cell assembly being reflected by said standard deviation σ_{Ucell} being lower than said predetermined threshold standard deviation σₜₕᵣₑₛₕ.

Water flooding in the cell assembly means an accumulation of water in the cell assembly.

According to another aspect of the invention, a fuel cell system management method is proposed comprising a device for supplying hydrogen to the fuel cell assembly and a compressor for supplying air to said fuel cell assembly, said fuel cell assembly consisting of cells arranged in N_{mod} modules. The method comprises steps in which:

voltages are measured across the terminals of each cell of each module of said cell assembly;

a standard deviation σ_{Ucell} of said voltages measured across the terminals of the cells of the cell assembly is calculated;

said standard deviation σ_{Ucell} is compared with a predetermined threshold standard deviation σₜₕᵣₑₛₕ; and

the presence or absence of water flooding in the cell assembly is determined on the basis of said comparison, the presence of water flooding in the cell assembly being reflected by said standard deviation σ_{Ucell} being equal to or higher than said predetermined threshold standard deviation σₜₕᵣₑₛₕ, and the absence of water flooding in the cell assembly being reflected by said standard deviation σ_{Ucell} being lower than said predetermined threshold standard deviation σₜₕᵣₑₛₕ.

In a preferred embodiment, in case of the presence of water flooding in the cell assembly, said water flooding is drained.

In an advantageous embodiment, said predetermined threshold standard deviation value σₜₕᵣₑₛₕ depends on the operating mode of the fuel cell assembly, said fuel cell assembly comprising, as operating modes, a start mode, a nominal mode, and a stop mode.

In a preferred embodiment, in case of the presence of water flooding in the cell assembly:

a standard deviation of the voltages measured across the terminals of the cells of the module is calculated for each respective module;

the module having the highest of said standard deviations calculated for each module is determined; and

said water flooding is drained exclusively for said module having the highest of said standard deviations, which is the most water-flooded module.

In an advantageous embodiment, said water flooding is drained by increasing the anode and cathode gas flow rates entering each module or entering the most water-flooded module.

In a preferred embodiment, said water flooding is drained by setting the anode and cathode outlets of each module or the anode and cathode outlets of the most water-flooded module at atmospheric pressure.

According to the invention, a fuel cell system management system is also proposed, comprising a reformer for supplying a hydrogen-containing reformed gas to the fuel cell assembly, a compressor for supplying air to said fuel cell assembly, and an electronic control unit, said fuel cell assembly consisting of cells arranged in N_{mod} modules. The system comprises:

a sensor of the voltage across the terminals of each of said cells of the cell assembly, connected to the electronic control unit to transmit voltage measurements across the terminals of a respective cell;

a device for removing the carbon monoxide poisoning in the cell assembly;

a device for draining the water flooding in the cell assembly;

means for controlling said devices for removing carbon monoxide poisoning and for draining the water flooding in the cell assembly; and

processing means in the electronic control unit, receiving the measurements from said sensors of the voltage across the terminals of each of said respective cells and supplying signals to said control means, said processing means comprising computation means and comparison means.

In a preferred embodiment, said carbon monoxide poisoning removal device in the cell assembly comprises a valve controlled by said control means, connected to said compressor to regulate an air flow rate added to said reformed gas.

According to the invention, a second management system for managing a second fuel cell system is proposed, comprising a device for supplying hydrogen to the fuel cell assembly, a compressor for supplying air to said fuel cell assembly and an electronic control unit, said fuel cell assembly consisting of cells arranged in N_{mod} modules. The system comprises:

a sensor of the voltage across the terminals of each of said cells of the cell assembly, connected to the electronic control unit to transmit voltage measurements across the terminals of a respective cell;

a device for draining the water flooding in the cell assembly;

means for controlling said devices for removing carbon monoxide poisoning and for draining the water flooding in the cell assembly; and

processing means in the electronic control unit, comprising computation means suitable for calculating a standard deviation σ_{Ucell} of said voltages measured across the terminals of the cells of the fuel cell assembly, and comparison means for comparing said standard deviation σ_{Ucell} with a predetermined threshold standard deviation σₜₕᵣₑₛₕ, said processing means being suitable for determining therefrom the presence or absence of water flooding in the cell assembly, the presence of water flooding in the cell assembly being reflected by said standard deviation σ_{Ucell} being equal to or higher than said predetermined threshold standard deviation σ_{Uthresh}, and the absence of water flooding in the cell assembly being reflected by said standard deviation σ_{Ucell} being lower than said predetermined threshold standard deviation σₜₕᵣₑₛₕ.

In an advantageous embodiment, the device for draining the water flooding in the cell assembly comprises a valve, controlled by said control means, for adjusting the total feed rate of the cathodes of the modules or N_{mod} valves controlled by said control means, for adjusting the respective feed rate of the cathode of each module.

In a preferred embodiment, the device for draining the water flooding in the cell assembly comprises a valve controlled by said control means, for adjusting the total feed rate of the anodes of the modules or N_{mod} valves controlled by said control means, for adjusting the respective feed rate of the anode of each module.

In an advantageous embodiment, the device for draining the water flooding in the cell assembly comprises a valve, controlled by said control means, for setting the total cathode outlet of the fuel cell assembly at atmospheric pressure or N_{mod} valves, controlled by said control means, for setting the respective cathode outlet of each module at atmospheric pressure.

In a preferred embodiment, the device for draining the water flooding in the cell assembly comprises a valve, controlled by said control means, for setting the total anode outlet of the fuel cell assembly at atmospheric pressure or N_{mod} valves, controlled by said control means, for setting the respective anode outlet of each module at atmospheric pressure.

Other objects, features and advantages of the invention will appear from a reading of the following description, provided only as a nonlimiting example, and with reference to the drawings appended hereto in which:

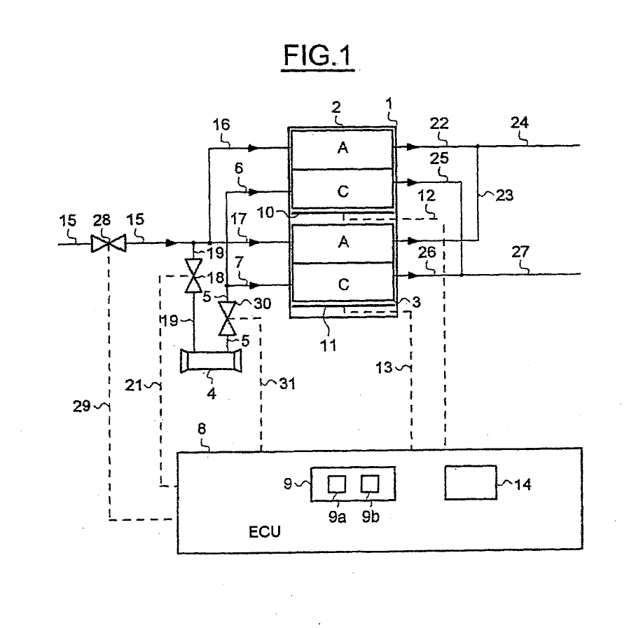

FIG. 1 shows a first embodiment of a system according to the invention, supplied with reformed gas;

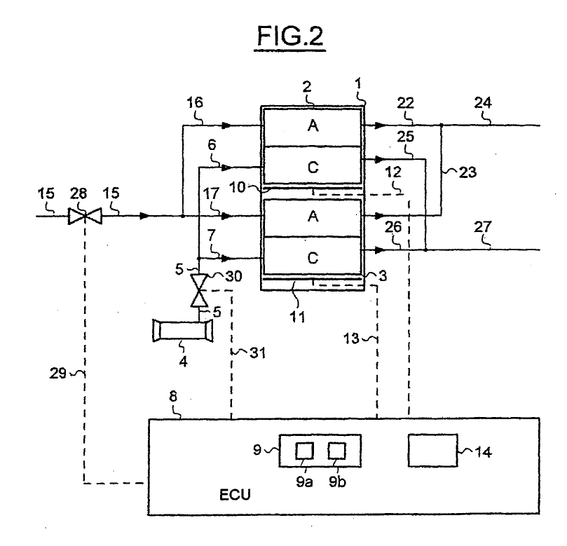

FIG. 2 shows a first embodiment of a system according to the invention, supplied with hydrogen;

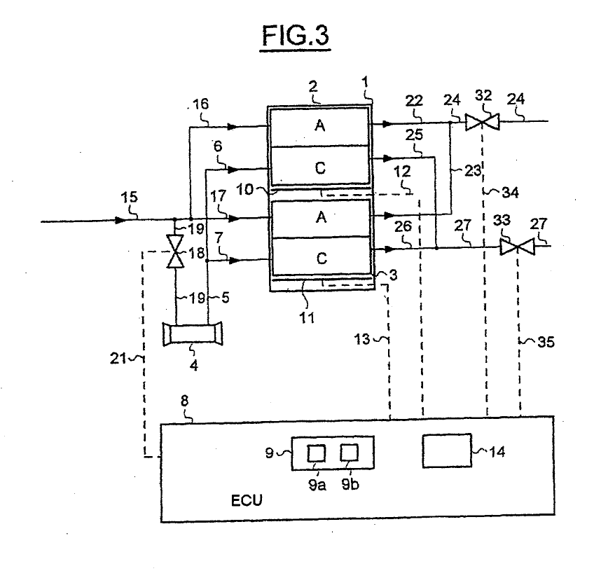

FIG. 3 shows a second embodiment of a system according to the invention, supplied with reformed gas;

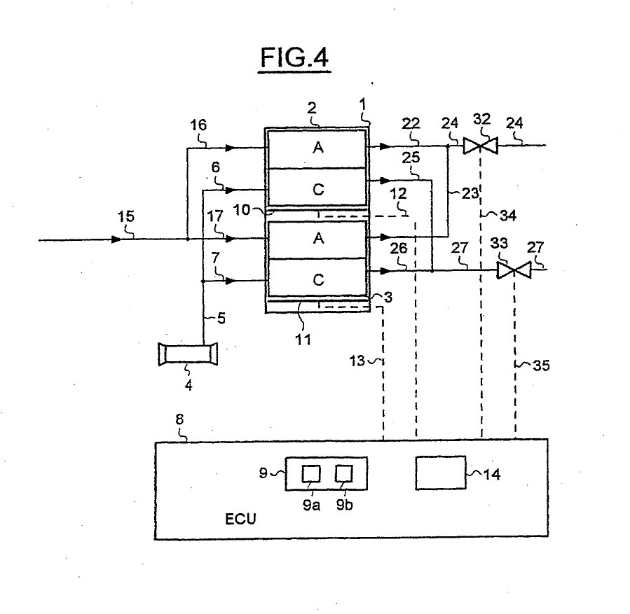

FIG. 4 shows a second embodiment of a system according to the invention, supplied with hydrogen;

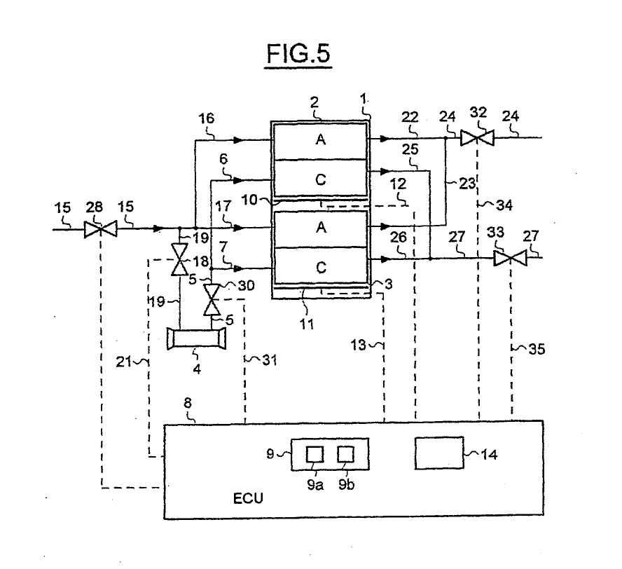

FIG. 5 shows a third embodiment of a system according to the invention, supplied with reformed gas;

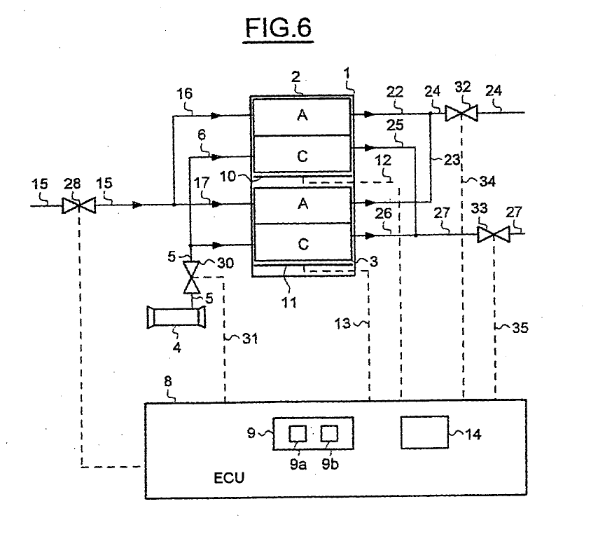

FIG. 6 shows a third embodiment of a system according to the invention, supplied with hydrogen;

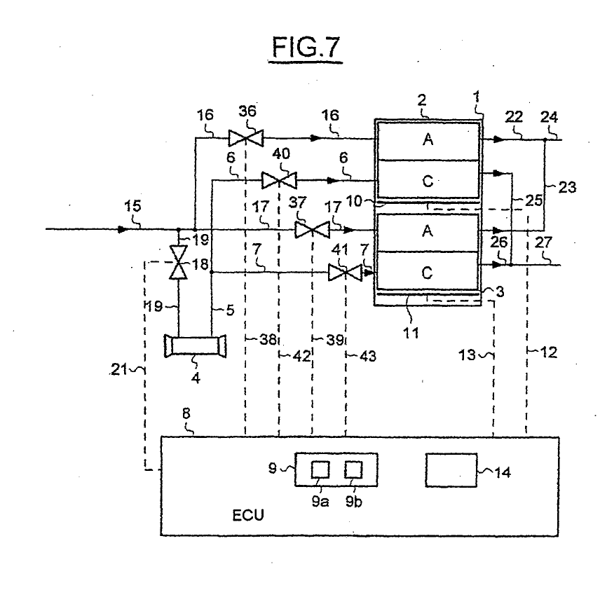

FIG. 7 shows a fourth embodiment of a system according to the invention, supplied with reformed gas;

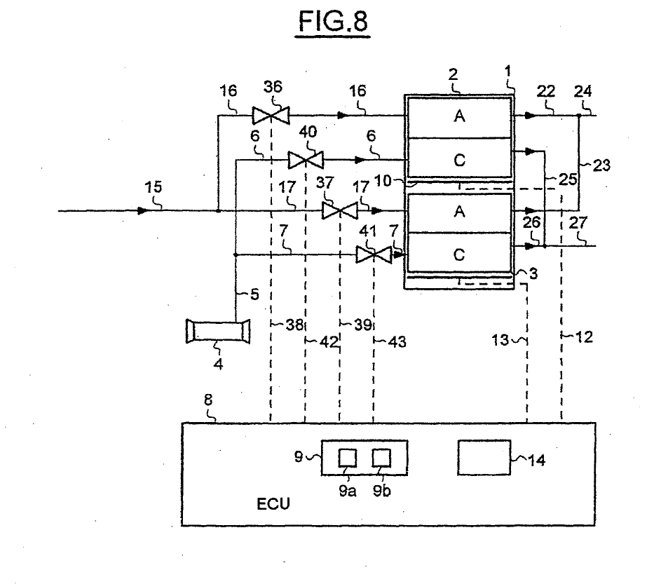

FIG. 8 shows a fourth embodiment of a system according to the invention, supplied with hydrogen;

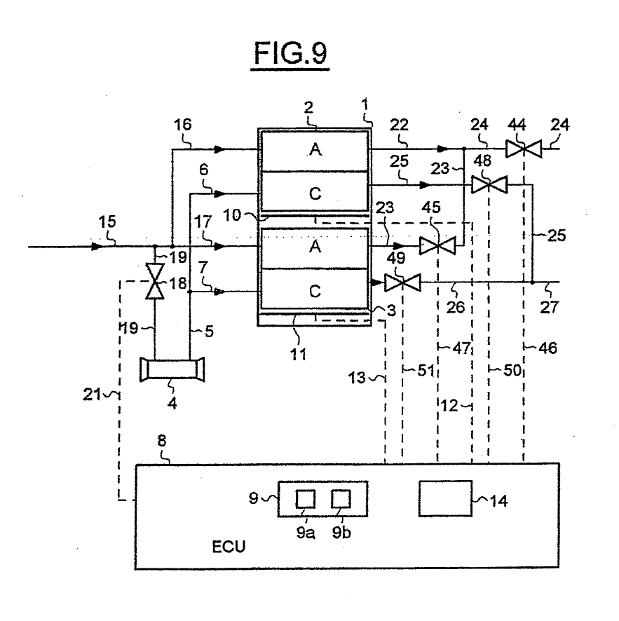

FIG. 9 shows a fifth embodiment of a system according to the invention, supplied with reformed gas;

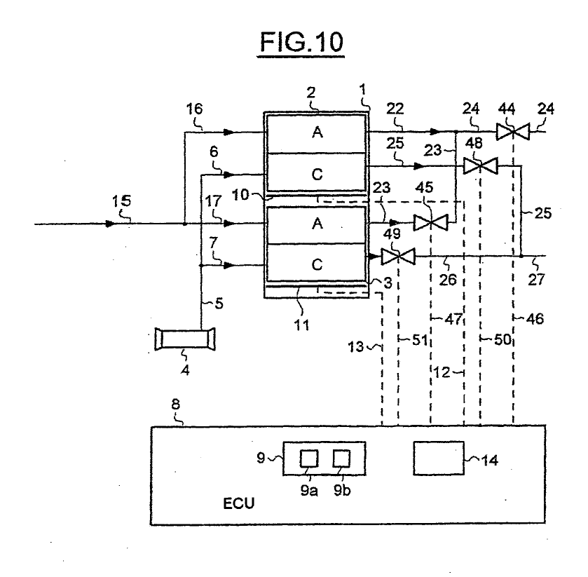

FIG. 10 shows a fifth embodiment of a system according to the invention, supplied with hydrogen;

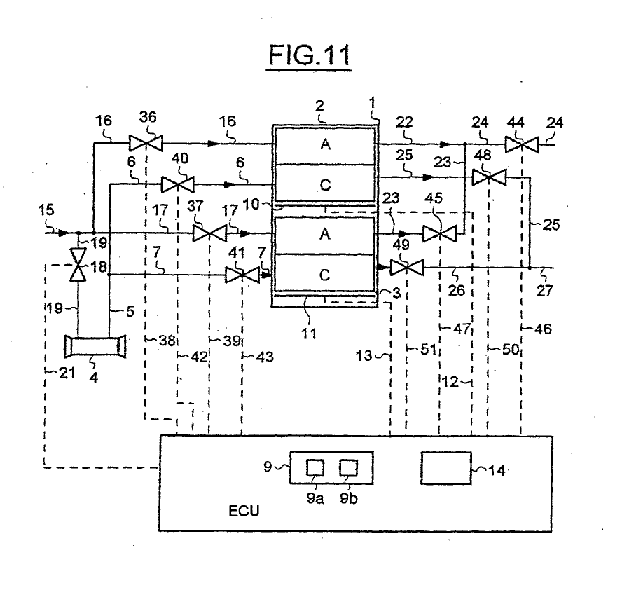

FIG. 11 shows a sixth embodiment of a system according to the invention, supplied with reformed gas;

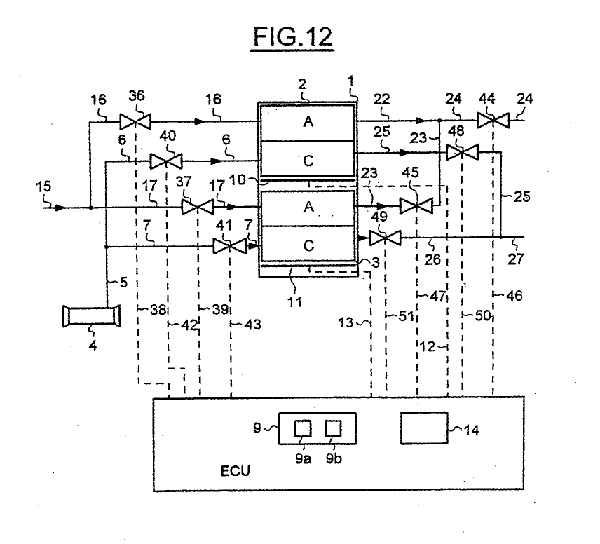

FIG. 12 shows a sixth embodiment of a system according to the invention, supplied with hydrogen;

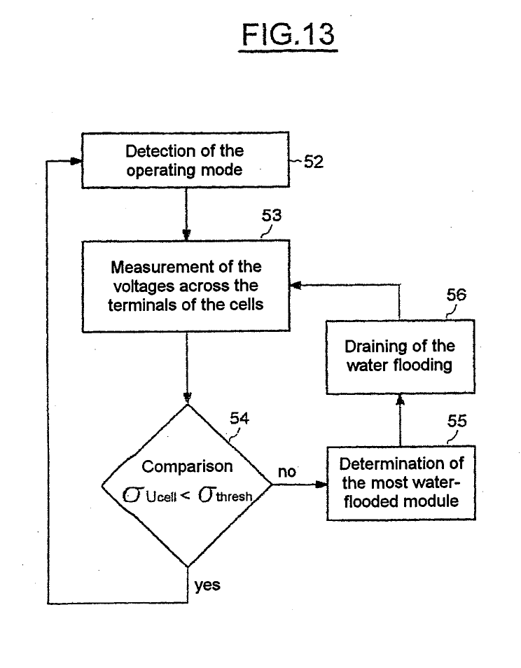

FIG. 13 shows a first embodiment of a method according to the invention;

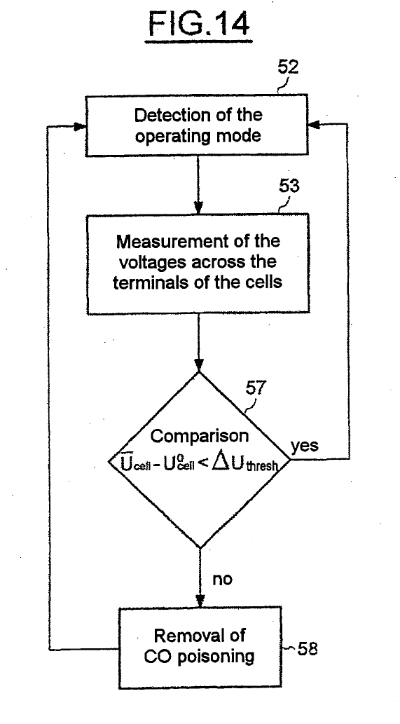

FIG. 14 shows a second embodiment of a method according to the invention; and

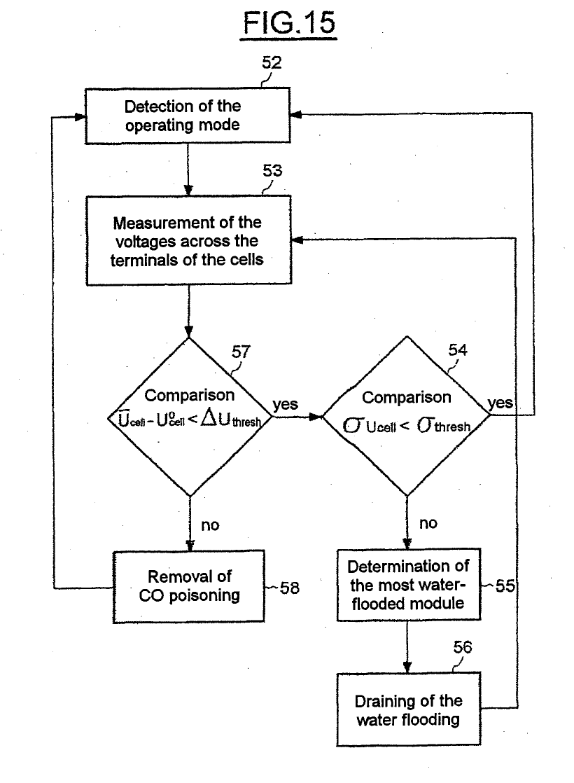

FIG. 15 shows a third embodiment of a method according to the invention.

FIG. 1 shows a fuel cell assembly 1 consisting of a set of cells arranged in N_{mod} modules. In the figures, the case in which N_{mod}=2 is shown, but the description is valid for all integers of N_{mod}, including the value 1. The cells of the fuel cell assembly 1 are accordingly distributed in 2 modules 2, 3. Each module 2, 3 comprises an anode part A and a cathode part C. The system also comprises an air compressor 4 for supplying oxygen to the cathode parts C of the modules 2, 3 of the fuel cell assembly 1. This overall oxygen supply is provided via a line 5 connected to the compressor 4 which supplies pressurized air. The line 5 is split into two lines 6 and 7 supplying oxygen to the cathodes C of the respective modules 2, 3 of the fuel cell assembly 1.

An electronic control unit or UCE 8 comprises processing means 9 suitable for detecting a carbon monoxide poisoning and a water flooding in the fuel cell assembly 1 based on measurements transmitted by sets 10, 11 of sensors of the voltage across the terminals of the respective cells of each module 2, 3.

The processing means 9 comprise computation means 9a and comparison means 9b. The sets 10, 11 of sensors are connected to the electronic control unit 8 via respective connections 12, 13. The electronic control unit 8 also comprises control means 14 suitable for controlling a device for draining the water flooding of the cell assembly 1, and one for removing the carbon monoxide poisoning of the cell assembly 1.

A total reformed gas supply line 15 supplies hydrogen-containing reformed gas to supply the anodes A of the various modules 2, 3 of the fuel cell assembly 1, by splitting into respective feed lines 16, 17. The reformer supplying the line 15 is not shown in the figure.

Since the feed is hydrogen-containing reformed gas, and not hydrogen, there is a risk of carbon monoxide poisoning of the fuel cell assembly 1. A device for removing the carbon monoxide poisoning in the cell assembly 1 is also further provided. The carbon monoxide poisoning removal device comprises a controlled valve 18, traversed by a line 19 connecting the compressor 4 to the line 15. The controlled valve 18 serves to adjust an air flow rate added to the reformed gas feed of the cathodes C of the modules 2, 3 of the fuel cell assembly 1. Increasing the air flow rate to the total reformed gas feed serves to remove or drain a carbon monoxide poisoning. The controlled valve 18 is connected to the electronic control unit 8 by a connection 21.

Respective discharge lines 22, 23 from the anodes A of each module 2, 3 of the fuel cell assembly 1, meet in a combined outlet 24 of the anodes A of the modules 2, 3 of the fuel cell assembly 1. Similarly, discharge lines 25, 26 from the cathodes C of each respective module 2, 3 of the fuel cell assembly 1, meet in a combined outlet 27 of the cathodes C of the modules 2, 3 of the fuel cell assembly 1.

The system further comprises a device for draining the water flooding in the fuel cell assembly 1 which comprises a controlled valve 28 traversed by the total reformed gas feed line 15 and connected to the electronic computation unit 8 via a connection 29. The device for draining the water flooding of the fuel cell assembly 1 also comprises a controlled valve 30 traversed by the total air, and hence oxygen, feed line 5 to the fuel cell assembly 1. The controlled valve 30 is connected to the electronic control unit 8 by a connection 31. The controlled valves 28, 30 serve to temporarily increase the respective total feed flow rates of the fuel cell assembly 1 when a water flooding is detected, in order to drain the water flooding.

FIG. 2 shows a similar system to that shown at FIG. 1, but in which the total feed of the anodes A of the modules 2, 3 of the cell assembly 1 is hydrogen. Since the feed is hydrogen, and not a hydrogen containing reformed gas, there is no risk of carbon monoxide poisoning in the cell assembly 1. Hence the system does not comprise any device to remove carbon monoxide poisoning, and therefore no controlled valve 18, line 19, nor connection 21. The hydrogen feed device of the line 15 is not shown in the figure.

FIG. 3 shows a similar system to the one shown in FIG. 1 previously described, but for which the device for draining water flooding in the fuel cell assembly 1 does not comprise the controlled valves 28 and 30, but comprises a controlled valve 32 for setting the overall anode outlet 24 of the modules 2, 3 of the fuel cell assembly 1 to atmospheric pressure. The water flooding drainage device further comprises a controlled valve 33 for setting the overall cathode outlet 27 of the modules 2, 3 of the fuel cell assembly 1 to atmospheric pressure. These two valves 32, 33 of the overall anode and cathode outlets are connected respectively to the electronic control unit 8 by connections 34, 35. The controlled valves 32, 33 serve to temporarily set the anodes A and the cathodes C of the modules 2, 3 of the fuel cell assembly 1 to atmospheric pressure, and thereby to drain a water flooding in the cell assembly 1.

FIG. 4 shows a similar system to that shown in FIG. 3, but in which the overall feed of the anodes A of the modules 2, 3 of the cell assembly 1 is hydrogen. Since the feed is hydrogen, and not hydrogen-containing reformed gas, there is no risk of carbon monoxide poisoning in the cell assembly 1. Hence the system does not comprise any carbon monoxide poisoning removal device, and hence no controlled valve 18, line 19, nor connection 21. The hydrogen feed device of the line 15 is not shown in the figure.

FIG. 5 shows a similar system to those shown in FIGS. 1 and 3, previously described, which combines the two water flooding drainage devices shown in FIGS. 1 and 3. The device for draining water flooding in the fuel cell assembly 1 comprises the controlled valves 28, 30, 32 and 33, and their respective connections 29, 31, 34 and 35, which serve to drain a water flooding in the fuel cell assembly 1 by simultaneously combining their operation described above. This simultaneous combination serves to improve the efficiency of the device for removing the water flooding of the cell assembly, particularly by accelerating the drainage.

FIG. 6 shows a similar system to the one shown in FIG. 5, but in which the overall feed of the anodes A of the modules 2, 3 of the cell assembly 1 is hydrogen. Since the feed is hydrogen, and not hydrogen-containing reformed gas, there is no risk of carbon monoxide poisoning in the cell assembly 1.

Hence the system does not comprise any carbon monoxide poisoning removal device, and hence no controlled valve 18, line 19, nor connection 21. The hydrogen feed device of the line 15 is not shown in the figure.

FIG. 7 describes a similar system to the one shown in FIG. 1, but in which the controlled valve 28 for total reformed gas feed is replaced by a set of controlled valves 36, 37 for adjusting the respective reformed gas feed rates of the respective anodes A of the modules 2, 3, of the cell assembly 1. The controlled valves 36, 37 are connected to the electronic control unit 8 by respective connections 38, 39. Moreover, the controlled valve 30 for total air feed is replaced by a set of controlled valves 40, 41 for adjusting the respective air feed inlet rates of the respective cathodes C of the modules 2, 3 of the cell assembly 1. The controlled valves 40, 41 are connected to the electronic control unit 8 by respective connections 42, 43. This serves to drain the water flooding in the cell assembly only in the water-flooded module, in other words, in the most water-flooded module of the cell assembly 1. The processing means 9 are then capable of determining the most water-flooded module.

FIG. 8 shows a similar system to the one shown in FIG. 7, but in which the total feed of the anodes A of the modules 2, 3 of the cell assembly 1 is hydrogen. Since the feed is hydrogen, and not hydrogen-containing reformed gas, there is no risk of carbon monoxide poisoning in the cell assembly 1. Hence the system does not comprise any carbon monoxide poisoning removal device, and hence no controlled valve 18, line 19, nor connection 21. The hydrogen feed device of the line 15 is not shown in the figure.

FIG. 9 describes a similar system to the one shown in FIG. 3, but in which the controlled valves 32 and 33 for setting the overall anode and cathode outlets 24, 27 to atmospheric pressure are replaced by respective sets of controlled valves for setting the respective modules 2, 3 of the cell assembly 1 to atmospheric pressure. Controlled valves 44, 45 for setting the anodes A of the respective modules 2, 3 of the cell assembly 1 to atmospheric pressure are connected to the electronic control unit 8 via respective connections 46, 47. Controlled valves 48, 49 for setting the cathodes C of the respective modules 2, 3 of the cell assembly 1 to atmospheric pressure are connected to the electronic control unit 8 via respective connections 50, 51. This serves to drain the water flooding in the cell assembly only in the water-flooded module, in other words, in the most water-flooded module, of the cell assembly 1. The processing means 9 are then capable of determining the most water-flooded module.

FIG. 10 shows a similar system to the one shown in FIG. 9, but in which the total feed of the anodes A of the modules 2, 3 of the cell assembly 1 is hydrogen. Since the feed is hydrogen, and not hydrogen-containing reformed gas, there is no risk of carbon monoxide poisoning in the cell assembly 1. Hence the system does not comprise a carbon monoxide poisoning removal device, and hence no controlled valve 18, line 19, nor connection 21. The hydrogen feed device of the line 15 is not shown in the figure.

FIG. 11 shows a similar system to those shown in FIGS. 7 and 9 previously described, which combines the two water flooding drainage devices shown in FIGS. 7 and 9. The water flooding drainage device in the fuel cell assembly 1 comprises controlled feed valves 36, 37, 40, 41 and controlled valves for setting to atmospheric pressure 44, 45, 48, 49. This simultaneous combination serves to improve the efficiency of the selective water flooding drainage device of the cell assembly, particularly by accelerating the drainage in the most water-flooded module.

FIG. 12 shows a similar system to the one shown in FIG. 11, but in which the total feed of the anodes A of the modules 2, 3 of the cell assembly 1 is hydrogen. Since the feed is hydrogen, and not hydrogen-containing reformed gas, there is no risk of carbon monoxide poisoning in the cell assembly 1. Hence the system does not comprise any carbon monoxide poisoning removal device, and hence no controlled valve 18, line 19, nor connection 21. The hydrogen feed device of the line 15 is not shown in the figure.

Any other combination is obviously valid, for example, a combination of a total controlled feed valve and controlled feed valves of the respective modules.

FIG. 13 shows an embodiment of the method according to the invention in the case of a hydrogen feed, and not reformed gas feed, to the system. The method begins with a step 52 for detecting the operating mode of the fuel cell assembly 1. The cell assembly 1 comprises, as operating modes, a start mode, a nominal mode, and a stop mode.

In the next step 53, the voltages, or potential differences, are measured across the terminals of the cells of the cell assembly 1, by means of the sets 10, 11 of the sensors of the voltage across the terminals of the respective cells of each module 2, 3. Each cell voltage measurement is transmitted to the electronic control unit 8. The computation means 9a of the processing means 9 calculate a standard deviation σ_{Ucell} of said voltages measured across the terminals of the cells of the cell assembly. This standard deviation σ_{Ucell} is calculated using the following equation:

$${σ}_{{U}_{cell}} = \sqrt{\frac{1}{{\sum }_{k = 1}^{{N}_{mod}} {N}_{cell\_mod} ( k )} {\sum }_{j = 1}^{{N}_{mod}} ( {\sum }_{i = 1}^{{N}_{cell\_mod ( j )}} {( {U}_{i}^{j} ( t ) - {\overline{U}}_{cell} ( t ) )}^{2} )} \qquad ( 1 )$$

where:
N_{cell}_{_{—}}_{mod} (k) is the number of cells of the module k;
N_{mod} is the number of modules of the fuel cell assembly 1;
U|(t) is the voltage across the terminals of the cell i of the module j and at a time t; and
Ū_{cell}(t) is the mean voltage across the terminals of a cell of the cell assembly 1 at time t.

The mean voltage Ū_{cell}(t) across the terminals of a cell of the cell assembly 1 at time t, is defined by the equation:

$${\overline{U}}_{cell} ( t ) = \frac{1}{{\sum }_{k = 1}^{{N}_{mod}} {N}_{cell\_mod} ( k )} {\sum }_{j = 1}^{{N}_{mod}} {\sum }_{i = 1}^{{N}_{cell\_mod ( j )}} {U}_{i}^{j} ( t ) \qquad ( 2 )$$

All these equations are obviously equally valid if the number of modules N_{mod} of the cell assembly 1 is equal to 1.

In the next step 54, the comparison means 9b of the processing means 9 make a comparison between the standard deviation σ_{Ucell} calculated and a predetermined threshold standard deviation value σₜₕᵣₑₛₕ depending on the operating mode of the fuel cell assembly.

If the standard deviation σ_{Ucell} is lower than the predetermined threshold standard deviation σₜₕᵣₑₛₕ, the method continues with said step 52, because of the absence of water flooding in the fuel cell assembly.

If the standard deviation σ_{Ucell} is equal to or higher than the predetermined threshold standard deviation σₜₕᵣₑₛₕ, the process then continues with an optional step 55 for determining the most water-flooded module. This step is optional, because it is useless if the cell assembly 1 only comprises one module, or if the device for draining the water flooding in the cell assembly 1 only comprises controlled valves for adjusting the total feeds or the overall setting to atmospheric pressure of the modules of the cell assembly 1, as shown in FIGS. 2, 4 and 6. It is carried out by the systems shown in FIGS. 8, 10 and 12.

When said step 55 is carried out, it is done by calculating a standard deviation of the voltages of the cells of each module, and by determining the module having the highest of these standard deviations, which is the most water-flooded module.

The standard deviation σ^{j}_{Ucell} of a module j is calculated by the computation means 9a of the processing means 9, using the equation:

$${σ}_{{U}_{cell}}^{j} = \sqrt{\frac{1}{{N}_{cell\_mod} ( j )} {\sum }_{i = 1}^{{N}_{cell\_mod} ( j )} {( {U}_{i}^{j} ( t ) - {\overline{U}}_{cell} ( t ) )}^{2}} \qquad ( 3 )$$

Then, in a step 56, the control means 14 drains the water flooding of the cell assembly 1 or the most water-flooded module, depending on the presence or absence of step 55, a presence depending on the system. Step 53 is then carried out.

FIG. 14 shows an embodiment of the method according to the invention in the case of a reformed gas, and not hydrogen, feed to the system. Hence there may be a presence of carbon monoxide poisoning in the cell assembly 1. The method begins with steps 52 and 53. In step 53, it is not necessary in this embodiment to calculate the standard deviations mentioned. However, the computation means 9a further calculate a voltage difference between a mean cell voltage Ū_{cell} for the cell assembly 1 and a predetermined mean cell voltage U⁰_{cell}. The predetermined mean cell voltage U⁰_{cell} represents a mean voltage in the absence of carbon monoxide poisoning in the cell assembly 1. During a carbon monoxide poisoning in the cell assembly 1, all the voltages across the terminals of the cells of the cell assembly 1 drop, contrary to the case of water flooding, where only the voltages across the terminals of the flooded cells drop.

This is followed by a step 57 of comparison during which the comparison means 9b of the processing means 9 compare said voltage difference Ū_{cell}−U⁰_{cell} with a predetermined threshold voltage difference ΔUₜₕᵣₑₛₕ which depends on the operating mode of the system.

If the voltage difference Ū_{cell}−U⁰_{cell} is lower then the predetermined threshold voltage difference ΔUₜₕᵣₑₛₕ, the method continues with step 52.

If the voltage difference Ū_{cell}−U⁰_{cell} is equal to or greater than the predetermined threshold voltage difference ΔUₜₕᵣₑₛₕ, during a step 58, the control means 14 control a carbon monoxide poisoning removal device, for example, like the one shown in FIGS. 1, 3, 5, 7, 9 and 11.

FIG. 15 shows an embodiment of the method according to the invention in the case of a reformed gas, and not hydrogen, feed to the system, combining the steps of the two methods previously described, when taking account of the risks of carbon monoxide poisoning and the risks of water flooding in the fuel cell assembly.

Hence the invention serves to optimize the operation of a fuel cell assembly, by detecting a carbon monoxide poisoning and a water flooding in the fuel cell assembly and by eliminating the presence of carbon monoxide poisoning and by draining a water flooding.

The invention also serves to drain a water flooding of the cell assembly per module of the cell assembly, in order to target the drainage.

1-17. (canceled)

18: A fuel cell system management method including a reformer for supplying a hydrogen-containing reformed gas to a fuel cell assembly and a compressor for supplying air to the fuel cell assembly, the fuel cell assembly including cells arranged in modules, the method comprising:
measuring voltages across terminals of each cell of each module of the cell assembly;
calculating a voltage difference between a mean cell voltage for the cell assembly and a predetermined mean cell voltage;
comparing the voltage difference with a predetermined threshold voltage difference; and
determining a presence of carbon monoxide poisoning in the cell assembly if the voltage difference is equal to or greater than the predetermined threshold voltage difference, and determining an absence of carbon monoxide poisoning in the cell assembly if the voltage difference is lower than the predetermined threshold voltage difference.

19: The method as claimed in claim 18, wherein the predetermined mean cell voltage and the predetermined threshold voltage difference depend on an operating mode of the fuel cell assembly, the fuel cell assembly comprising, as operating modes, a start mode, a nominal mode, and a stop mode.

20: The method as claimed in claim 18, wherein in case of the presence of carbon monoxide poisoning in the cell assembly, air is added to the reformed gas.

21: The method as claimed in claim 19, wherein in case of the absence of carbon monoxide poisoning in the cell assembly,
a standard deviation of the voltages measured across the terminals of the cells of the cell assembly is calculated;
the standard deviation is compared with a predetermined threshold standard deviation; and
presence or absence of water flooding in the cell assembly is determined based on the comparison, the presence of water flooding in the cell assembly being reflected by the standard deviation being equal to or higher than the predetermined threshold standard deviation, and the absence of water flooding in the cell assembly being reflected by the standard deviation being lower than the predetermined threshold standard deviation.

22: A fuel cell system management method including a device for supplying hydrogen to a fuel cell assembly and a compressor for supplying air to the fuel cell assembly, the fuel cell assembly including cells arranged in modules, the method comprising:
measuring voltages across terminals of each cell of each module of the cell assembly;
calculating a standard deviation of the voltages measured across the terminals of the cells of the cell assembly;
comparing the standard deviation with a predetermined threshold standard deviation; and
determining presence or absence of water flooding in the cell assembly based on the comparison, the presence of water flooding in the cell assembly being reflected by the standard deviation being equal to or higher than the predetermined threshold standard deviation, and the absence of water flooding in the cell assembly being reflected by the standard deviation being lower than the predetermined threshold standard deviation.

23: The method as claimed in claim 21, wherein in case of the presence of water flooding in the cell assembly, the water flooding is drained.

24: The method as claimed in claim 21, wherein the predetermined threshold standard deviation value depends on an operating mode of the fuel cell assembly, the fuel cell assembly comprising, as operating modes, a start mode, a nominal mode, and a stop mode.

25: The method as claimed in claim 21, wherein in case of the presence of water flooding in the cell assembly:
a standard deviation of the voltages measured across the terminals of the cells of the module is calculated for each respective module;
the module having the highest of the standard deviations calculated for each module is determined; and
the water flooding is drained exclusively for the module having the highest of the standard deviations, which is a most water-flooded module.

26: The method as claimed in claim 25, wherein the water flooding is drained by increasing anode and cathode gas flow rates entering each module or entering a most water-flooded module.

27: The method as claimed in claim 21, wherein the water flooding is drained by setting anode and cathode outlets of each module or anode and cathode outlets of a most water-flooded module at atmospheric pressure.

28: A fuel cell system management system comprising:
a reformer for supplying a hydrogen-containing reformed gas to a fuel cell assembly, the fuel cell assembly including cells arranged in modules;
a compressor for supplying air to the fuel cell assembly;
an electronic control unit;
a sensor of a voltage across terminals of each of the cells of the cell assembly, connected to the electronic control unit to transmit voltage measurements across the terminals of a respective cell;
a device for removing carbon monoxide poisoning in the cell assembly;
a device for draining water flooding in the cell assembly;
control means for controlling the devices for removing carbon monoxide poisoning and for draining the water flooding in the cell assembly; and
processing means in the electronic control unit, for receiving measurements from the sensors of the voltage across the terminals of each of the respective cells and supplying measurement signals to the control means, the processing means comprising computation means and comparison means.

29: The system as claimed in claim 28, wherein the carbon monoxide poisoning removal device comprises a valve controlled by the control means, connected to the compressor, for regulating an air flow rate added to the reformed gas.

30: A fuel cell system management system comprising:
a device for supplying hydrogen to the fuel cell assembly, the fuel cell assembly including cells arranged in modules;
a compressor for supplying air to the fuel cell assembly;
an electronic control unit;
a sensor of the voltage across terminals of each of cells of the cell assembly, connected to the electronic control unit to transmit voltage measurements across the terminals of a respective cell;
a device for draining water flooding in the cell assembly;
control means for controlling the device for draining the water flooding in the cell assembly; and
processing means in the electronic control unit, comprising computation means for calculating a standard deviation of the voltages measured across the terminals of the cells of the fuel cell assembly, and comparison means for comparing the standard deviation with a predetermined threshold standard deviation, the processing means determining therefrom presence or absence of water flooding in the cell assembly, the presence of water flooding in the cell assembly being reflected by the standard deviation being equal to or higher than the predetermined threshold standard deviation, and the absence of water flooding in the cell assembly being reflected by the standard deviation being lower than the predetermined threshold standard deviation.

31: The system as claimed in claim 30, wherein the device for draining the water flooding in the cell assembly comprises a valve controlled by the control means for adjusting a total feed rate of cathodes of the modules or valves controlled by the control means, for adjusting a respective feed rate of the cathode of each module.

32: The system as claimed in claim 30, wherein the device for draining the water flooding in the cell assembly comprises a valve controlled by the control means for adjusting a total feed rate of anodes of the modules or valves controlled by the control means, for adjusting a respective feed rate of the anode of each module.

33: The system as claimed in claim 30, wherein the device for draining the water flooding in the cell assembly comprises a valve, controlled by the control means, for setting a total cathode outlet of the fuel cell assembly at atmospheric pressure or valves controlled by the control means, for setting a respective cathode outlet of each module to atmospheric pressure.

34: The system as claimed in claim 30, wherein the device for draining the water flooding in the cell assembly comprises a valve, controlled by the control means, for setting a total anode outlet of the fuel cell assembly at atmospheric pressure or valves controlled by the control means, for setting a respective anode outlet of each module to atmospheric pressure.
